(19) United States
(12) Patent Application Publication
(10) Pub. No.: US 2013/0009945 A1
(43) Pub. Date: Jan. 10, 2013

(54) Electronic Display Method and Apparatus

(76) Inventor: Niall Thomas Davidson, Hamilton (GB)

(21) Appl. No.: 13/177,664

(22) Filed: Jul. 7, 2011

(51) Int. Cl. G06T 15/00

(52) U.S. Cl. 345/419

(57) ABSTRACT

A method and apparatus for displaying images on a viewing surface using a single image source to generate different portions of the image, the combined image having a higher resolution than the image source. A first apparatus switches images using a micro-electro-mechanical systems mirror array onto the viewing surface, the images being received perpendicular to the viewing surface. A second apparatus uses a movable scanning mirror in one or two axes to reflect images off of a parabolic mirror perpendicularly onto the viewing surface.

### BACKGROUND

Consumer pressure drives the electronic display industry to increase display size and resolution whilst reducing costs and there has been a recent demand for entertainment delivered using 3D display technologies. This has seen the development of larger resolution, higher pixel density display devices and the development of various display technologies with stereoscopic display capability, some of which require the use of specific 3D glasses. Unfortunately some people report suffering headaches whilst viewing some variants of this technology and using 3D glasses to view the images is undesirable.

Auto-stereoscopic displays exist which do not require 3D glasses, however these devices typically present a small number of views or have limited or specific viewing angles, therefore an auto-stereoscopic display capable of delivering a large number of views is desirable.

### SUMMARY

I have observed that display devices are generally constructed with deference to a peculiarity of human biology, that is we construct displays devices such that a frame rate within our own ability to perceive is developed. This somewhat arbitrary requirement provides us with an opportunity to improve upon display devices by developing the potential of increased frame rates beyond those perceivable by the human eye.

Electronic displays embodying features of the present invention direct each of a series of images to one of a plurality of locations at speeds high enough that the illusion of a single image being displayed is created. In this way display devices can be developed which, amongst other benefits, are larger or are of a higher resolution or pixel density.

Embodiments of the present invention may be used to particular advantage in the context of multi-view auto-stereoscopic displays, where by increasing the available pixel density a high density light field auto-stereoscopic display is made possible. Benefits of the present invention are however not limited to use within a multi-view auto-stereoscopic display and can be used to the advantage of various types of display devices including, but not limited to 2D displays.

Particular embodiments may optionally include optics for adapting to the viewing surface the images being generated whilst in yet other particular embodiments the image is optionally directed to the viewing surface so that it is received perpendicular to the plane of the viewing surface.

### DRAWINGS

These and other features, aspects, and advantages of the present invention will become better understood with regard to the following description, appended claims, and accompanying drawings where:

FIGS. 1 to 5 show example lens clusters;

FIG. 6 shows a viewing surface and selected lens clusters;

FIG. 7 is a diagram showing a perspective view of a first apparatus embodying principles of the invention;

FIG. 8 is a diagram showing the apparatus of FIG. 7 in a side view;

FIG. 9 is a diagram showing the apparatus of FIG. 7 in a top view;

FIG. 10 is a flowchart of the logic for the control means operating the apparatus of FIG. 7;

FIG. 11 is a diagram outlining the row and column layout of the MEMS devices of FIG. 7;

FIG. 12 is a diagram showing a composite MEMS mirror array;

FIG. 13 is a diagram showing a perspective view of the first apparatus of FIG. 7 with the composite MEMS mirror array of FIG. 12;

FIG. 14 is a diagram showing a perspective view of a second apparatus embodying principles of the invention;

FIG. 15 is a diagram showing the apparatus of FIG. 14 in a top view;

FIG. 16 is a diagram showing the apparatus of FIG. 14 in a side view;

FIG. 17 is a figure showing elements of an embodiment of the second apparatus placed in a coordinate system;

FIG. 18 is a flowchart of the logic for the control means operating the apparatus of FIG. 14, and;

FIG. 19 is a diagram of a viewing surface of an embodiment of the second apparatus divided into areas.

### DESCRIPTION

It is intended that the following description and claims should be interpreted in accordance with Webster's Third New International Dictionary, Unabridged unless otherwise indicated.

The term “optically positioned” as found in the following specification and claims is defined to mean that the device or object being “optically positioned” is positioned with regards to its optical properties or capabilities, it is not intended to require the use of optical means or instrumentation to position or align the device or object.

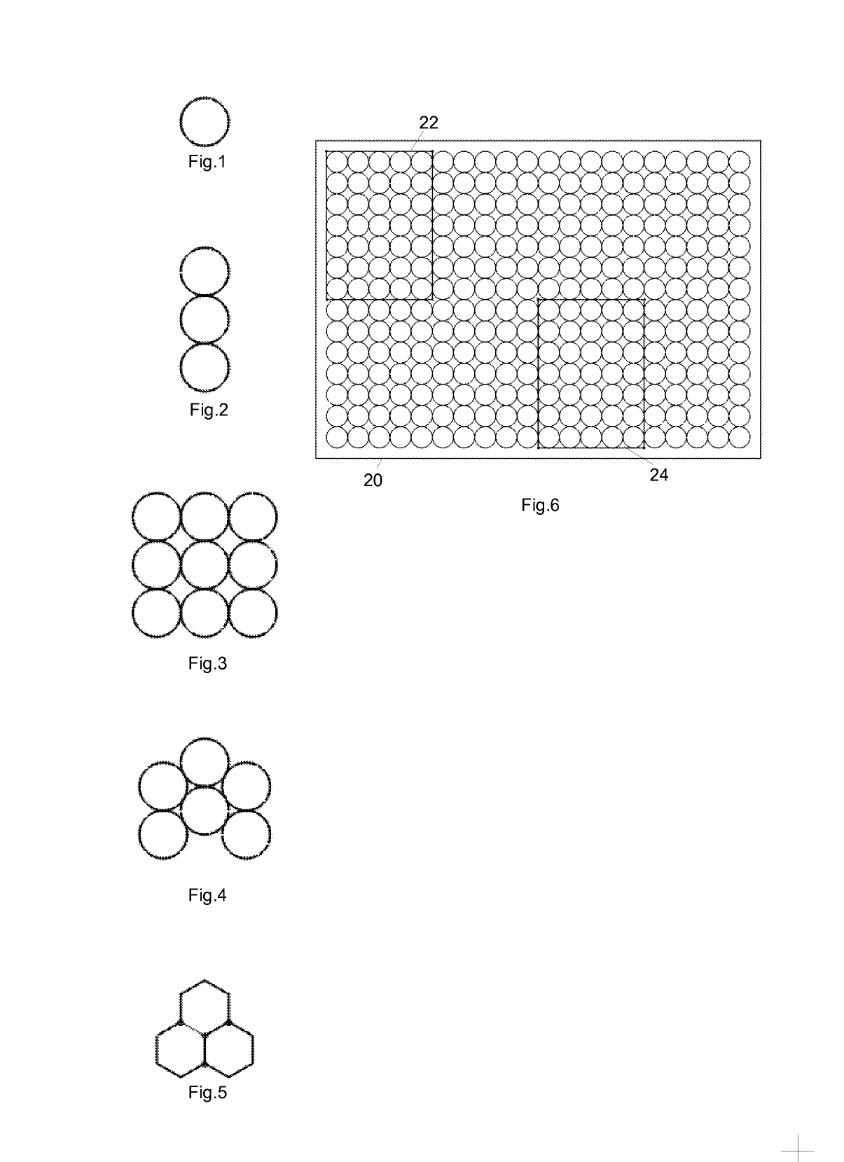

A “lens cluster” as found in the following specification and claims is defined as being an area on a viewing surface, where the viewing surface comprises an array of lenses; the lens cluster comprising one or more lenses of the lens array. Various examples of possible lens cluster configurations are shown in FIGS. 1 to 5, the figures are illustrative of the concept only and are not intended to limit the definition of a lens cluster to the examples shown. A description of the broader concept of areas on a viewing surface will be discussed in more detail below.

A “sequence of images” as found in the following specification and claims is defined as being two or more consecutive images.

An “outline of an area” as found in the following specification and claims is defined to be a continuous line which marks the outer limits of an area. The outline of an area for a continuous area is its boundary, and the outline of a non-continuous area is defined to be the shortest path which can be drawn around the non-continuous area without crossing itself.

A method for displaying visual information is described, the method comprising: dividing a viewing surface into areas; generating an image for each frame in a set of frames; optionally adapting the generated images, and; directing each generated image onto a different area of the viewing surface.

The step of dividing a viewing surface into areas is a conceptual division of the viewing surface into a plurality of areas. There is no restriction on what defines an area of the viewing surface and therefore a viewing surface may be divided into a plurality of areas, one, some or all of which are the same or different sizes, overlapping, non-overlapping, continuous, non-continuous, contiguous or non-contiguous.

By example, referring to FIG. 6; the viewing surface 20 is divided into a total of 8 non-overlapping areas, with a first area 22 and a second area 24 outlined. In the example of FIG. 6 there are 8 areas and each area is continuous, of a constant size and adjacent to other areas; this is for example only and is not a requirement of the described method.

The step of generating an image for each frame in a set of frames can be performed by any device, object or apparatus capable of generating an image for a given input frame and, hereafter such a device, object or apparatus is referred to as an “image source”. Suitable image sources include, but are not limited to Cathode Ray Tubes (CRT), Organic Light Emitting Diodes (OLED), Liquid Crystal Displays (LCD), Ferro-electric Liquid Crystal Displays (FLCD), Digital Mirror Devices (DMD), Grating Light Valves (GLVs), Surface conductor Electron emission Displays (SED), Plasma Display Panels (PDP), Field Emission Displays (FED) and equivalents.

The set of frames referred to by the step of generating an image for each frame in a set of frames are a set of frames in which each frame corresponds to an area of the viewing surface, with a full set fully describing the image to be displayed on the portions of the viewing surface covered by the areas of the dividing step. An individual set of frames is not required to contain a frame for each area on the viewing surface, however this may be required by some apparatus embodying the described method.

The images may be required to be generated in a specific order depending on how the viewing surface is divided and the displays intended use, for example if areas are overlapping then one frame may be required to be displayed before another. The order in which the images are generated will be relevant in the directing step and so care must be taken to ensure that if the order of display is relevant that the images are generated, and subsequently directed in the correct order.

In order to create the illusion of a single image being displayed over the entire viewing surface the entire set of images must be generated such that each area on the viewing surface receives an image at a rate such that the illusion is maintained. The rate at which each area on the viewing surface receives an image is the TargetRate and the FrameRate is the rate that the image source should generate images. A formula suitable for computing the required frame rate of the image source is then,

Framerate=TargetRate*MaxNumberOfAreas.

It is understood that displaying an image on an area at a frame rate of greater than 25 Hz but preferably at least 50 Hz will create the desired illusion, when we input 50 Hz into our formula and use the example viewing surface of FIG. 6 we find in that case that the image source of the example viewing surface requires a minimum frame rate of,

50 Hz (TargetRate)*8(MaxNumberOfAreas)=400 Hz (FrameRate).

The optional step of adapting the generated image is performed by optically adapting the image output from the image source by: optical means including but not limited to lenses, prisms or mirrors; mechanical means including but not limited to a mask or other occulting means positioned in the image path, or; a combination of both optical and mechanical means. The purpose of this step is to adapt the image output to the area where it will be displayed on the viewing surface or to adapt the image so that it is suitable for direction by the directing means, this may require the image to be magnified or reduced in size or manipulated in some other manner.

The step of directing each generated image onto a different area of the viewing surface can be performed optically, mechanically or by a combination of both; its purpose is to direct each image generated in the image generating step to the area on the viewing surface where it is to be viewed. Each image generated by the generating step being directed to the appropriate location on the viewing surface as it is being generated by the image source.

Amongst the advantages of the described method are that displays which have higher resolutions, higher pixel densities, larger display sizes, smaller image sources, or require cheaper or less complex image sources can be created.

Multi-view auto-stereoscopic devices can particularly benefit from the described method as increased pixel density and increased resolution can deliver a greater number of views.

The method and apparatus embodying principles of the method are therefore used to display an arbitrary image on a viewing surface by creating a set of frames from the image, each frame corresponding to the portion of the arbitrary image as defined by the step of dividing the viewing surface into areas. The set of frames then being displayed in accordance with the above method.

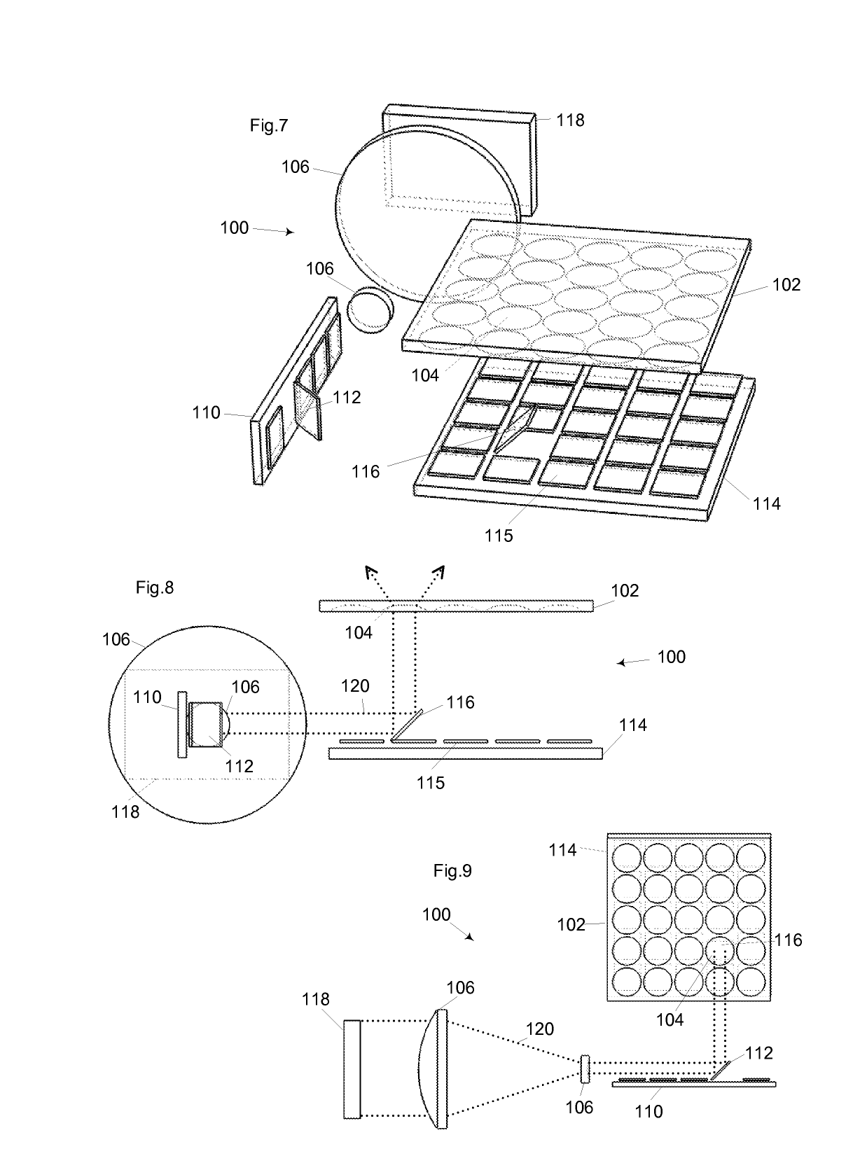

A first apparatus embodying principles of the invention is described, the apparatus 100 shown in FIGS. 7,8 and 9 functioning as an auto-stereoscopic display device.

The apparatus 100 comprising: an image source 118 for generating an image for each frame in a set of frames; reducing optics comprising lenses 106 for adapting the generated images; a first microelectromechanical systems (MEMS) mirror array 110 and a second MEMS mirror array 114 for directing each generated image onto a different area of the viewing surface, and; a viewing surface 102 comprising a plurality of lenses.

The viewing surface 102 comprises an array of uniform concave microlenses, the lenses shaped, sized and oriented to diverge light received from the second MEMS mirror array 114; light being received perpendicular to the plane of the viewing surface 102 from the second MEMS mirror array 114. Such microlens arrays are widely available and are well-known, the method of manufacture or other specific properties of the microlens arrays is not specified, however examples of suitable microlens arrays are described in U.S. Pat. No. 7,583,333 or U.S. Pat. No. 5,886,760.

It is not required that the viewing surface 102 comprises an array of uniform concave microlenses, many other alternatives are possible, including but not limited to: a viewing surface comprising an array of convex microlenses; viewing surfaces similar to those used by rear projection televisions or cinema screens; a viewing surface such as a conveniently located wall or whiteboard, or; any other surface that allows an image to be formed upon it. Use of a viewing surface comprising uniform concave microlenses is described because it illustrates a particular use of the described apparatus as an auto-stereoscopic display, and the apparatus should not be construed as being limited to such a viewing surface.

The first MEMS mirror array 110 and the second MEMS mirror array 114 each comprise a plurality of movable mirrors and are a means for directing the image output from the image source 118 to one of a plurality of areas on the viewing surface 102. The mirrors being: parallel with the surface of the substrate when not actuated, as exemplified by mirror 115; capable of being actuated to make an angle of 45° with the plane of the surface of the substrate, as exemplified by mirror 116 and mirror 112, and; independently actuated with a frequency as determined by the rate with which each area on the viewing surface is to display an image.

The mirrors of the first MEMS mirror array 110 and second MEMS mirror array 114 may, instead of being parallel with the surface of the substrate when not actuated, be designed such that the mirror is held at an angle or in a position when not actuated which does not cause the mirror to impinge upon the image path of other mirrors and does not cause the undesirable reflection of incident light received from the viewing surface back to the viewing surface.

The MEMS mirror arrays can be fabricated, for example, using commercially available Multi-user MEMS processing (MUMPs) services which are available from, amongst others, MEMSCAP, Inc located at Research Triangle Park, N.C. Information on actuators which are suitable may be found in U.S. Pat. No. 6,708,491 or Cowan et al. “Vertical Thermal Actuator for Micro-Opto-Electro-Mechanical Systems”, v.3226, SPIE, pp. 137-146 (1997); however other suitable designs and techniques for the fabrication of the MEMS mirror arrays are known to those skilled in the art.

The individual lenses of the viewing surface 102, the mirrors of the first MEMS mirror array 110 and the mirrors of the second MEMS mirror array 114 are all configured in such a way that light from the image source 118 can be directed by an actuated mirror on the first MEMS mirror array 110 to an actuated mirror on the second MEMS mirror array 114 and subsequently directed to a lens cluster on the viewing surface 102.

Whilst other arrangements of the various components described below are possible, the particular arrangement described was chosen because one of its advantages is that images are directed from the second MEMS mirror array 114 to the viewing surface 102 perpendicular to the plane of the lenses on the viewing surface 102. This has an advantage of simplifying the construction of the lenses on the viewing surface 102, allowing the use of an array of uniform lenses rather than individually configuring each lens depending on its position on the viewing surface 102.

The lenses of the viewing surface 102 are arranged in a grid pattern with uniform rows and columns, the diameter and optical characteristics of the lenses are defined by the desired aesthetic effect of the display device, however this may be constrained by the available size of the individual MEMS mirrors. The viewing surface 102 is divided into 25 lens clusters (areas), each lens cluster consisting of a single lens, this is in accordance with the above step of dividing the viewing surface into areas.

The grid pattern, number of lenses and the division into areas of the viewing surface 102 as shown in FIGS. 7,8 and 9 and described are illustrative of only one possible configuration. The pattern used is restricted only by the availability of a mirror array which can direct the images to the viewing surface in the desired manner and so patterns such as honeycomb, diamond grid or others are possible; further, dividing the viewing surface into lens clusters consisting of more than one lens is also a possibility. The particular arrangement of the lenses on the viewing surface 102 has a direct effect on the positioning and configuration of the mirrors on the first MEMS mirror array 110 and the second MEMS mirror array 114 also and so the particular pattern of the mirrors should also be understood to be illustrative only.

The second MEMS mirror array 114 comprises one mirror for each lens cluster on the viewing surface 102, in this case 25 mirrors; the mirrors arranged in the same grid pattern as the lenses of the viewing surface 102 with each lens cluster of the viewing surface 102 having a counterpart mirror and each mirror of the second MEMS mirror array 114 being orientated similarly on the substrate.

The second MEMS mirror array 114 is positioned relative to the viewing surface 102 as shown in FIGS. 7,8 and 9. The second MEMS mirror array 114 and the viewing surface 102 positioned such that: the plane of the second MEMS mirror array 114 and the plane of the viewing surface 102 are parallel; the mirrors of the second MEMS mirror array 114 and the lenses of the viewing surface 102 substantially aligned such that for each lens and counterpart mirror pair, a ray perpendicular to the plane of both the second MEMS mirror array 114 and the viewing surface 102 intersects the center of the lens and the center of the mirrored face of its counterpart mirror when the mirror is in its actuated position, for example see lens 104 and actuated mirror 116, and; the mirrored face of each mirror, in its actuated position reflects light received parallel to the plane of the second MEMS mirror array 114 towards the viewing surface 102.

The first MEMS mirror array 110 comprises one mirror for each row of mirrors on the second MEMS mirror array 114, with each mirror of the first MEMS mirror array 110 being similarly orientated on the substrate.

The first MEMS mirror array 110 is positioned relative to the second MEMS mirror array 114 as shown in FIGS. 7,8 and 9. The first MEMS mirror array 110 and the second MEMS mirror array 114 are positioned such that: the plane of the first MEMS mirror array 110 and the plane of the second MEMS mirror array 114 are perpendicular, and; the mirrors on the first MEMS mirror array 110 are substantially aligned with the mirrors on the second MEMS mirror array 114 so that for each mirror on the first MEMS mirror array 110 a ray perpendicular to the plane of the first MEMS mirror array 110 is parallel to the plane of the second MEMS mirror array 114 and intersects with the center of the mirrored face of the mirror on the first MEMS mirror array 110 when the mirror is actuated and intersects with the center of the mirrored face of each mirror in one row of the second MEMS mirror array 114 when the mirror on the second MEMS mirror array 114 is actuated, for example see actuated mirror 112 and actuated mirror 116, and; the mirrored face of the mirrors on the first MEMS mirror array 110 when the mirrors are in their non actuated position is facing the second MEMS mirror array 114.

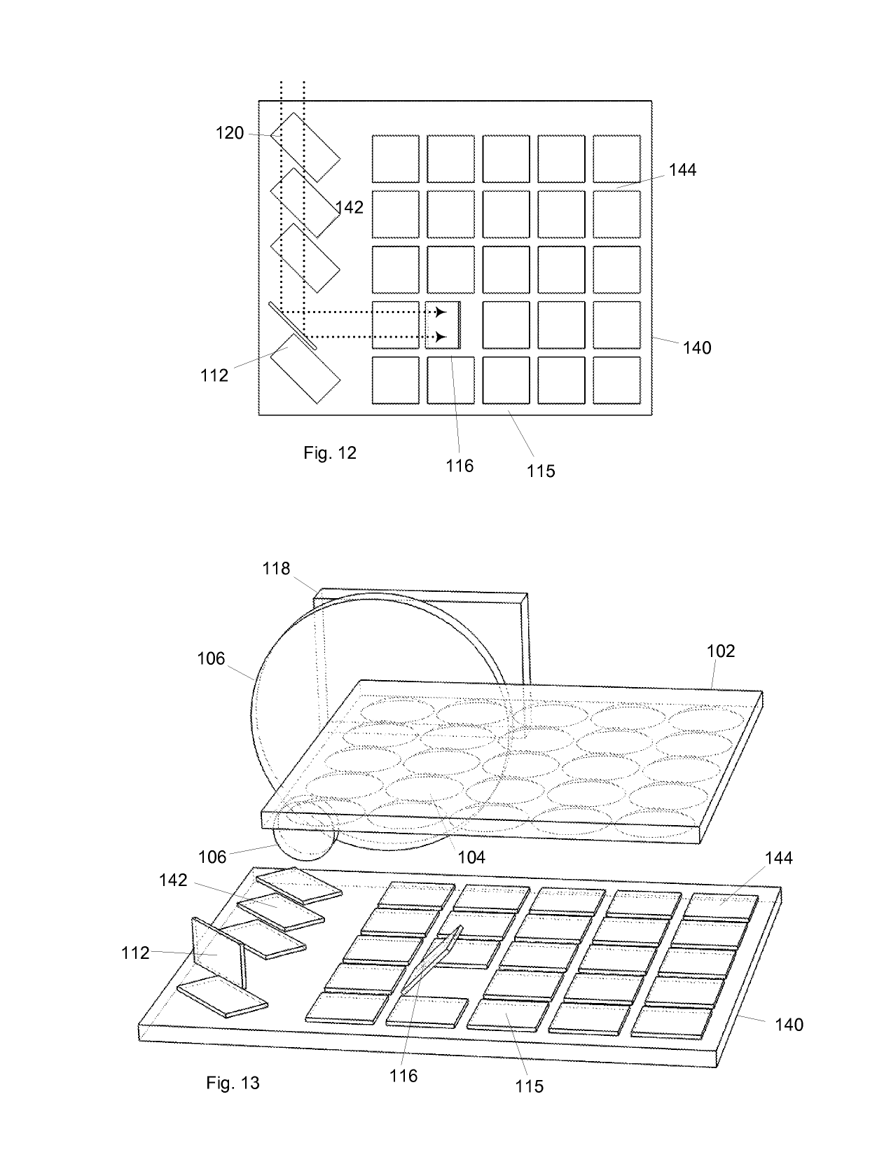

Referring to FIG. 11, which illustrates the rows and columns of the mirrors of the MEMS arrays; each mirror of the first MEMS mirror array 110 defines a row (rows A,B,C,D and E) and the mirrors of the second MEMS mirror array 114 correspond to the columns (columns 1,2,3,4 and 5) of each row as shown in the figure. For the purposes of this document the rows of the first MEMS mirror array 110 are assigned a capital letter and the columns of the second MEMS mirror array 114 are assigned a numeric value between 1 and 5, with the mirror of the first MEMS mirror array 110 closest to the image source being assigned the capital letter A.

The mirrors on the first MEMS mirror array 110 and the mirrors on the second MEMS mirror array 114 are cooperatively orientated on their substrates with respect to their axes of rotation. The mirrors on the first MEMS mirror array 110 are orientated on the substrate such that the normals projected from the center of each mirror when actuated are coplanar. The mirrors on each separate row of the second MEMS mirror array 114 are orientated on the substrate such that the normals projected from the center of each mirror when actuated are also coplanar. The above coplanar plane of the first MEMS mirror array 110 being perpendicular to the above coplanar plane of each separate row of the second MEMS mirror array 114.

Each mirror of the first MEMS mirror array 110 and the second MEMS mirror array 114 have a surface size which is as large as possible whilst still maintaining all the described relations and properties. As shown in FIGS. 7,8 and 9 this produces mirrors which are closely positioned on the surface of the substrate. Whilst FIGS. 7,8 and 9 show mirrors with a square mirrored surface the mirrors can be of any shape, including but not limited to hexagonal, circular or diamond; the shape will be primarily dictated by the pattern of the lens array on the viewing surface 102.

The reducing optics for adapting the generated image, comprising lenses 106, are optional and may not be necessary for all embodiments of the apparatus 100. The reducing optics reduce the image generated by the image source 118 to a size which will be reflected by an actuated mirror of the first MEMS mirror array 110 and an actuated mirror of the second MEMS mirror array 114 to be received by the viewing surface 102 without the image being cropped or otherwise malformed and being of the correct size for display. Whilst many optical designs for the reducing optics are possible, a design such as a Galileo or Kepler type refractor can perform this task.

As the total distance traveled by the images being switched through the MEMS mirror arrays is generally different for each receiving lens cluster, it is advantageous for the image to exit the reducing optics collimated so that it can be received identically by each receiving lens cluster.

The reducing optics 106 are optically positioned relative to the first MEMS mirror array 110 such that the reduced collimated image generated by the image source 118 is directed parallel to the plane of the first MEMS mirror array 110 and so that the center of the reduced collimated image intersects the center of the mirrored face of each mirror of the first MEMS mirror array 110 when the mirror is actuated, for example see FIG. 9 and light path 120.

The image source 118 for generating images from a set of frames is optically positioned relative to the reducing optics 106 such that the generated image is reduced and directed as described above. The image source 118 generates images at the frame rate as described in the above method description, for example the image source should operate at a minimum of 1250 Hz to generate an image for each of the 25 lens clusters shown in the figures at 50 frames per second. Suitable image sources are described above, however a Texas Instruments Digital Mirror Devices (DMD) device which is claimed to be capable of generating 32,552 binary images per second has characteristics satisfying the needs of the example embodiment of FIGS. 7,8 and 9.

The example image path 120 of an image generated by the image source 118 is first directed through the reducing optics 106 onto actuated mirror 112 on the first MEMS mirror array 110 which reflects the reduced collimated image onto the actuated mirror 116 on the second MEMS mirror array 114 which reflects the reduced collimated image onto the receiving lens cluster, lens 104.

Thus we can direct the image generated by the image source 118 to any lens cluster by actuating a mirror corresponding to its row on the first MEMS mirror array 110 and actuating a mirror corresponding to its column on the second MEMS mirror array 114. For example lens cluster 104 is at position D2 and will receive the generated image by actuating the mirror 112 at position D on the first MEMS mirror array 110 and the mirror 116 at row D column 2 on the second MEMS mirror array 114 when mirrors A,B,C on the first MEMS mirror array and the mirror at row D column 1 are not actuated.

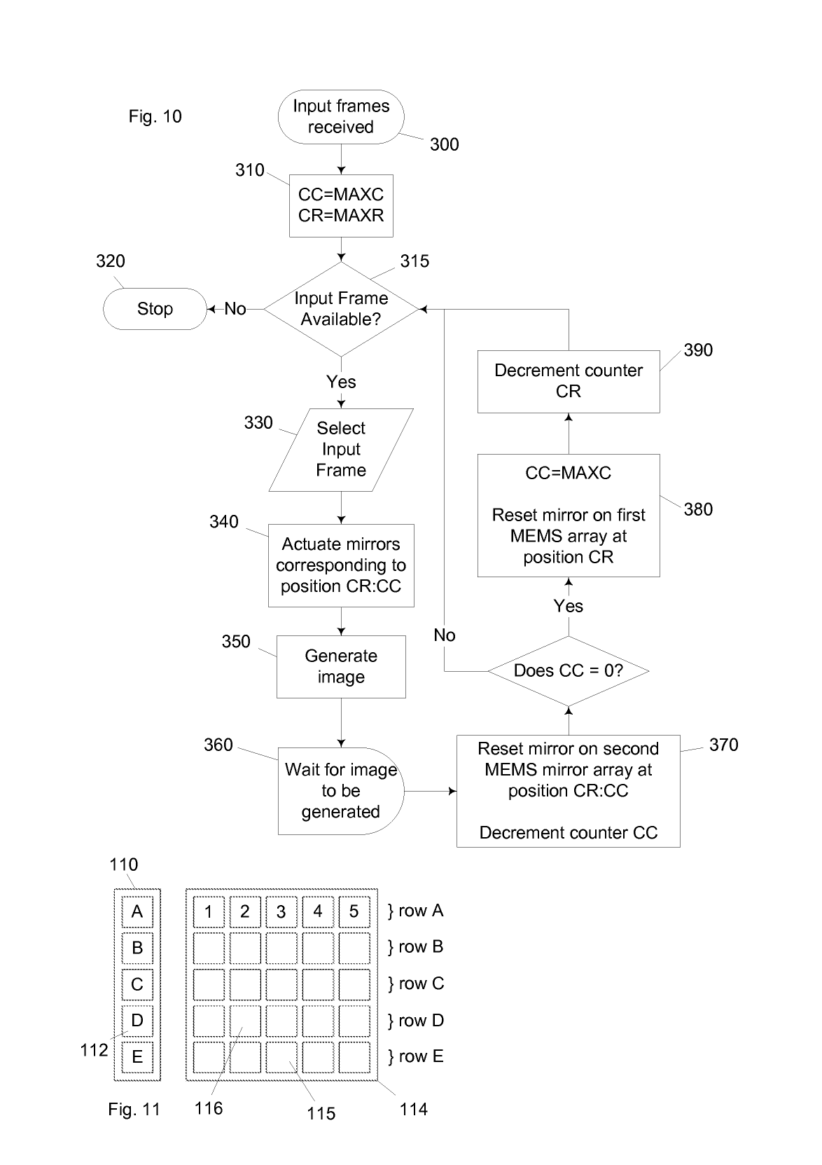

The apparatus 100 is operated by control circuitry or software means implementing the control logic as described in the flowchart of FIG. 10, the control logic responsive to the receipt of input frames appropriate to the viewing surface and its predetermined division into areas. In this case each input frame is associated with a lens cluster consisting of one lens.

Input frames are received ordered in complete rows with each row having MAXC frames and there being a total of MAXR rows, each row received sequentially from bottom to top (eg. starting with row E, then rows D,C,B and A) and the columns within each row are received with column MAXC being received first and column 1 received last. For example the implementation of the control means for the apparatus of FIGS. 7,8 and 9 will expect to receive each set of input frames in the order, E5,E4 . . . E1, D5 . . . , C5, . . . A1.

A row counter (CR) and a column counter (CC) are maintained by the control logic to track the current position in the input frames, the row counter CR mapping letters to numerals as follows, A to 1, B to 2, etc. It is assumed that all mirrors begin in a non actuated state, proper operation will ensure that all mirrors are in a non actuated state once a complete set of frames has been displayed.

On receipt of a new set of input frames (300) the counters are set (310), CC=MAXC, CR=MAXR.

If there are no more input frames in the current set the control logic stops (320) and waits for the next set of input frames, otherwise the next input frame in the set is selected (330) for display.

The image path is next set up (340) with the mirror at the position corresponding to row CR on the first MEMS mirror array 110 being actuated if it is not already in an actuated state and the mirror at the position corresponding to row CR and column CC on the second MEMS mirror array 114 being actuated.

The image associated with the selected input frame is generated (350) on the image source 118 and the control logic waits for the image to be completely generated (360).

The mirror at the position of the row counter CR and the column counter CC on the second MEMS mirror array 114 is reset to a non actuated state and the column counter decremented (370).

If CC=0 then the column counter is set to MAXC and the mirror at the position CR on the first MEMS mirror array 110 is reset to a non actuated state (380), CR is subsequently decremented (390) and the control logic returns to step 315; otherwise if CC≠0 the control logic returns to step 315.

An alternative directing means for the first apparatus shown in FIGS. 7,8 and 9 is described, the alternative directing means comprising a composite MEMS mirror array in place of the directing means comprising the first MEMS mirror array 110 and second MEMS mirror array 114 described above.

FIGS. 12 and 13 show the composite MEMS mirror array 140 which provides the same function and operates in substantially the same way as the two MEMS mirror arrays of the first apparatus described above, the composite MEMS mirror array 140 is a means for directing the image output from the image source 118 to one of a plurality of areas on the viewing surface 102. The composite MEMS mirror array 140 is fabricated on a single substrate, and among the advantages of the composite MEMS mirror array 140 is a reduced component count and reduced device complexity.

The composite MEMS mirror array 140 comprises two sets of mirrors, a first set of mirrors exemplified by mirror 142 which provide the same function as the mirrors of the first MEMS mirror array 110, and; a second set of mirrors exemplified by mirror 144 which provide the same function as the mirrors of the second MEMS mirror array 114.

For the properties and configuration of the second set of mirrors see the description for the mirrors of the second MEMS mirror array 114 above. The viewing surface 102 is positioned relative to the second set of mirrors on the composite MEMS mirror array 140 in the same manner in which the viewing surface 102 is positioned with regards to the second MEMS mirror array 114 in FIGS. 7,8 and 9.

The first set of mirrors of the composite MEMS mirror array 140 have properties such that they are: parallel with the surface of the substrate when not actuated, as exemplified by mirror 142; capable of being actuated to be perpendicular to the plane of the surface of the substrate, as exemplified by mirror 112, and; independently actuated with at least the frequency with which each area on the viewing surface is to display an image.

The mirrors of the first set of mirrors are configured such that when actuated: the plane of each mirror forms an angle of 45° to a ray passing through the center of the mirrored face of the mirror and the center of the mirrored face of each mirror of the associated row of the second set of mirrors when those mirrors are actuated; the plane of each mirror additionally forms an angle of 45° to a ray passing through the center of the mirrored face of the mirror and the center of the mirrored face of each other mirror of the first set of mirrors when each mirror of the first set of mirrors is actuated.

The mirrors of the first set of mirrors have a surface size which is as large as possible whilst still maintaining all the described relations and properties. As shown in FIGS. 12 and 13 this produces mirrors with a rectangular mirrored surface which are closely positioned on the surface of the substrate.

The reducing optics 106 are optically positioned relative to the first set of mirrors of the composite MEMS mirror array 140 such that the reduced collimated image of the image generated by the image source 118 is directed parallel to the plane of the composite MEMS mirror array 140 and so that the center of the reduced collimated image intersects the center of the mirrored face of each mirror of the first set of mirrors of the composite MEMS mirror array 140 when the mirror is actuated, for example see FIG. 12 and light path 120.

The mirrors of the composite MEMS mirror array 140 are operated by the same control logic and in the same manner as described above, substituting references to the first MEMS mirror array 110 with a reference to the first set of mirrors on the composite MEMS mirror array 140 and references to the second MEMS mirror array 114 with a reference to the second set of mirrors on the composite MEMS mirror array 140.

A further modification to the composite MEMS mirror array 140 directing means of the first apparatus is to provide multiple columns of the first set of mirrors and a plurality of associated image generating means and optional reducing means, a modification of this type will allow a plurality of images to be directed to different rows simultaneously and reduce the required frame rate of a single image source whilst servicing the same number of lens clusters.

A further alternative directing means for the first apparatus shown in FIGS. 7,8 and 9 is to use an array of mirrors in a similar configuration and similarly operated but of a larger scale, millimeters or centimeters rather than the scale of MEMS devices which are typically micrometers or less, such mirrors could be actuated by magnetic or mechanical means.

Yet another alternative directing means for the first apparatus shown in FIGS. 7,8 and 9 is to not use a first MEMS mirror array 110 or its alternative first set of mirrors of the composite MEMS mirror array 140, and instead position the optional reducing optics and image source in such a way that the generated image is directed onto the viewing surface by one of a row of mirrors similar to those that comprise the second MEMS mirror array 110 or the second set of mirrors of the composite MEMS mirror array 140.

Yet another alternative is for a movable scanning mirror to direct the generated and optionally reduced image onto one or more fixed mirrors which then direct the image onto an area of the viewing surface.

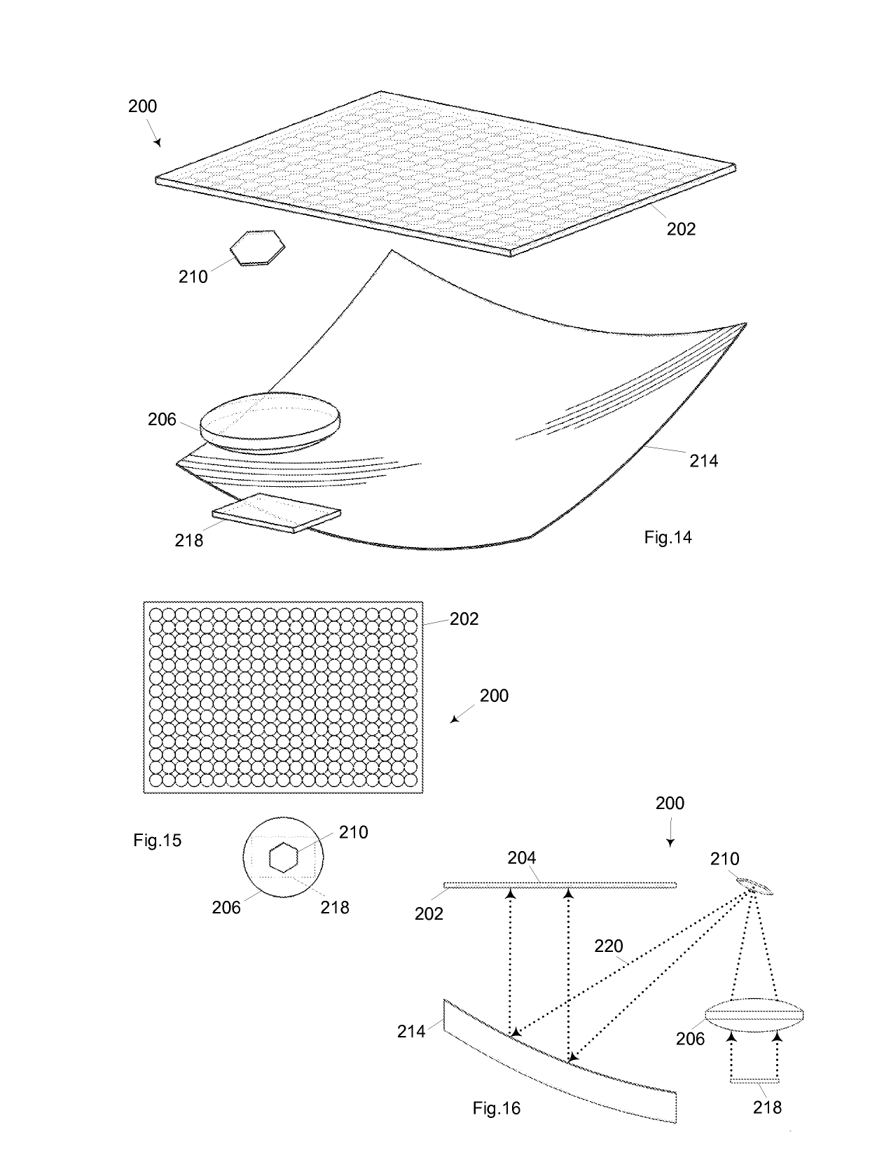

A second apparatus embodying principles of the invention is described, the apparatus 200 shown in FIGS. 14,15 and 16 functioning as an auto-stereoscopic display device.

The apparatus 200 comprising: an image source 218 for generating an image for each frame in a set of frames; focusing optics 206 for adapting the generated image; a movable scanning mirror 210 and a parabolic mirror 214 for directing each generated image onto a different area of the viewing surface, and; a viewing surface 202 comprising a plurality of lenses.

The viewing surface 202 comprises an array of uniform concave microlenses, the lenses shaped, sized and oriented to diverge light received from the parabolic mirror 214; light being received perpendicular to the plane of the viewing surface from the parabolic mirror 214. Such microlens arrays are widely available and are well-known, the method of manufacture or other specific properties of the microlens arrays is not specified, however examples of suitable microlens arrays are described in U.S. Pat. No. 7,583,333 or U.S. Pat. No. 5,886,760.

It is not required that the viewing surface 202 comprises an array of uniform concave microlenses, many other alternatives are possible, including but not limited to: a viewing surface comprising an array of convex microlenses; viewing surfaces similar to those used by rear projection televisions or cinema screens; a viewing surface such as a conveniently located wall or whiteboard, or; any other surface that allows an image to be formed upon it. Use of a viewing surface comprising uniform concave microlenses is described because it illustrates a particular use of the described apparatus as an auto-stereoscopic display, and the apparatus should not be construed as being limited to such a viewing surface.

The parabolic mirror 214 and the scanning mirror 210 are a means for directing the image output from the image source 218 to one of a plurality of areas on the viewing surface 202.

The parabolic mirror 214 is a paraboloid of revolution with a mirrored surface facing the focus of the paraboloid, and is similar to those found in reflecting astronomical telescopes; all or a portion of the parabolic mirror 214 being used to direct images reflected from the scanning mirror 210 onto the viewing surface 202. The central axis of the parabolic mirror 214 being the axis which passes through the vertex and focus of the paraboloid.

The viewing surface 202 positioned relative to the parabolic mirror 214 with the central axis of the parabolic mirror 214 being perpendicular to the plane of the viewing surface 202.

The scanning mirror 210 is a dual-axis or single-axis movable mirror operable in steps which has a point on the mirrored surface which occupies the same point in space regardless of its tilt, suitable devices include but are not limited to devices such as galvanometer mirror systems, scanning MEMS mirrors and step operable driven gimbal mounted mirrors. The scanning mirror 210 should be capable of making adjustments to its position at the same rate that the image source 218 generates images, the rate determined by the formula described in the step of generating the image, above.

The scanning mirror 210 is positioned relative to the parabolic mirror 214, with the point on the mirrored face of the scanning mirror 210 which occupies the same point in space regardless of its tilt positioned on the focus of the parabolic mirror 214 and the mirrored face of the scanning mirror 210 facing the mirrored surface of the parabolic mirror 214. The scanning mirror 210 may require cooling in order to operate under high power image sources, adequate cooling may be achieved by directing air over the mirrored surface using a fan, attaching a peltier type device to the rear surface of the mirror or using a liquid cooled mirror such as described in U.S. Pat. No. 4,772,110.

The image source 218 and the focusing optics 206 are optically positioned such that the images generated by the image source 218 are focused onto the scanning mirror 210 and reflected onto the parabolic mirror 214. Due to the position of the scanning mirror 210 occulting the view of the center portion of the parabolic mirror 214 making the occulted portion unsuitable for use reflecting an image it is useful, however not required, to locate the image source 218 and the focusing optics 206 on the central axis of the parabolic mirror 214.

The focusing optics 206 have a focal length such that: the image received from the image source 218 is focused onto the point on the mirrored surface of the movable mirror which occupies the same point in space regardless of its tilt, and; the image reflected from the scanning mirror 210 onto the parabolic mirror 214 is magnified or reduced in size as desired when subsequently reflected onto the viewing surface 202. The focusing optics 206 can be a single lens, multiple lenses or any other combination of optical devices required to achieve the goal described.

The image source 218 generates images at the frame rate as described in the above method description. Suitable image sources are described above, however a Texas Instruments Digital Mirror Devices (DMD) device which is claimed to be capable of generating 32,552 binary images per second has characteristics satisfying the needs of the example embodiment of FIGS. 14,15 and 16.

The images generated by the image source 218 are directed through the focusing optics 206 and reflected by the scanning mirror 210 onto the parabolic mirror 214 which reflects the image perpendicularly onto an area 204 of the viewing surface 202, an example image path 220 on FIG. 16 illustrates this.

Images displayed on the viewing surface 202 will be geometrically distorted, however this effect can be reduced by increasing the focal length of the parabolic mirror 214 and positioning the viewing surface 202 towards the central axis of the parabolic mirror 214. The frames associated with each image can also be transformed using well-known techniques such as interpolation before they are received by the apparatus, the techniques applied in such a way that the distortion is corrected for and the correct image is displayed. One way this can be accomplished is by mapping the desired output image to the viewing surface and using the function g(x,y) described below to create a transformed set of frames before sending them to the apparatus for display.

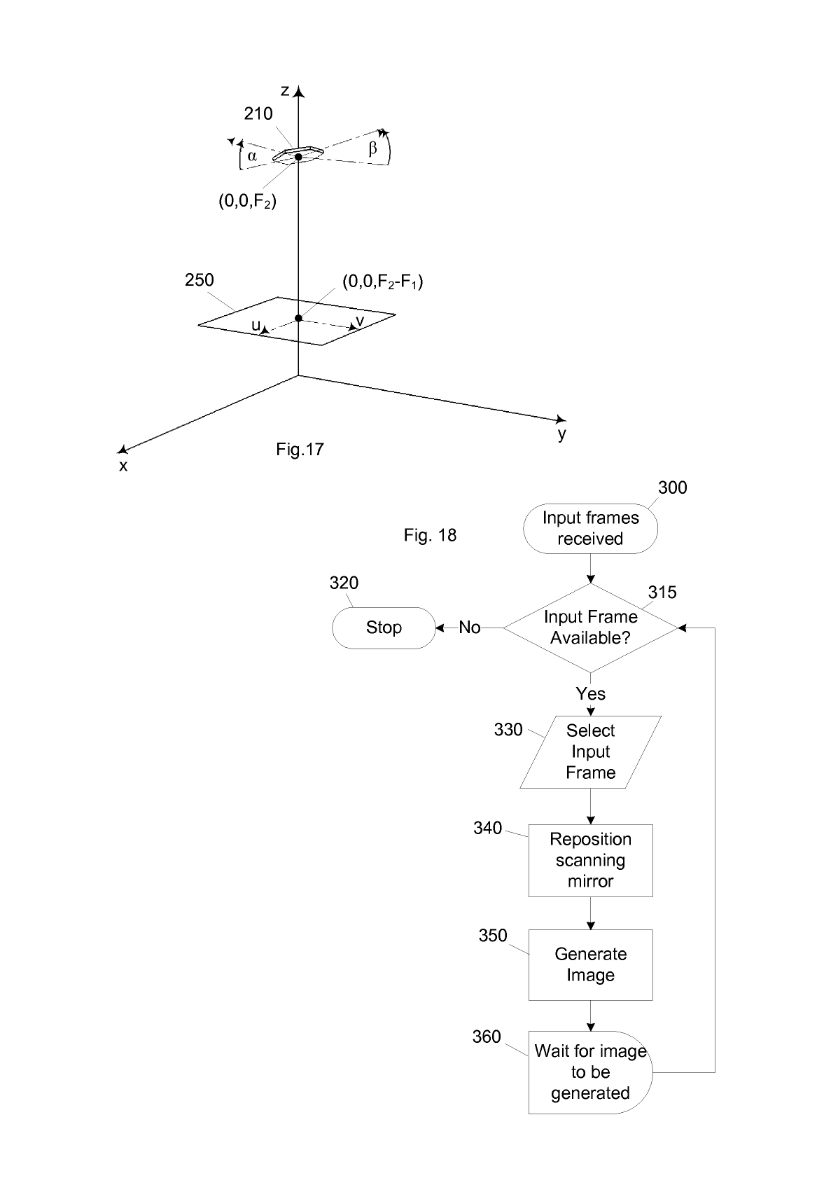

FIG. 17 illustrates some of the variables used in the equations below.

For an apparatus configured such that: the image source 218 and focusing optics 206 are positioned on the central axis of the parabolic mirror 214; the vertex of the parabolic mirror 214 lies on the origin and the central axis of the parabolic mirror 214 is coincident with the z-axis; the focusing optics 206 consists of a single lens and the plane 250 of the lens being perpendicular to the central axis of the parabolic mirror 214, and; the scanning mirror 210 has one axis of rotation aligned with the x-axis and another axis of rotation aligned with the y-axis; we can use the following function, f, to map the output of the image source 218 to the (x,y) coordinates of a viewing surface 202 positioned on the coordinate system as described above.

In FIG. 17 and the equations below, F₁ is the focal length of the focusing optics 206 exit lens; F₂ is the focal length of the parabolic mirror 214; a is the angle formed between the x-axis and the axis of rotation of the scanning mirror 210 which is aligned with the x-axis; β is the angle formed between the y-axis and the axis of rotation of the scanning mirror 210 which is aligned with the y-axis, and; (u,v) is the point on the image source 218 which is to be mapped.

The function yielding (x,y) for a given point (u,v) is

$$f ( u , v ) = \frac{2 {F}_{2} ( {r}_{3} + ‖ {r}^{->} ‖ )}{{r}_{1}^{2} + {r}_{2}^{2}} ( {r}_{1} , {r}_{2} )$$

$$where$$

$${r}^{->} = {a}^{->} - 2 \frac{1}{{‖ {n}^{->} ‖}^{2}} ( {n}^{->} \cdot {a}^{->} ) {n}^{->} = ( {r}_{1} , {r}_{2} , {r}_{3} )$$

and

\vec{a}=(−u,−v,F₁)=(a₁,a₂,a₃)

and

\vec{n}=(sin(α)cos(β),cos(α)sin(β),−cos(α)cos(β))

The inverse function, yielding (u,v) for a given point (x,y) is

$$g ( x , y ) = \frac{- {F}_{1}}{{s}_{3}} ( {s}_{1} , {s}_{2} )$$

$$where$$

$${s}^{->} = {b}^{->} - 2 \frac{1}{{‖ {n}^{->} ‖}^{2}} ( {n}^{->} \cdot {b}^{->} ) = ( {s}_{1} , {s}_{2} , {s}_{3} )$$

$$and$$

$${b}^{->} = ( - x , - y , {F}_{2} - \frac{{x}^{2} + {y}^{2}}{4 {F}_{2}} ) = ( {b}_{1} , {b}_{2} , {b}_{3} )$$

The required angles α, β can be calculated such that (u, v)→(x, y) with the equations,

$$α = arctan ( - \frac{‖ {b}^{->} ‖ {a}_{1} + ‖ {a}^{->} ‖ {b}_{1}}{‖ {a}^{->} ‖ {b}_{3} + ‖ {b}^{->} ‖ {a}_{3}} ) , \\ β = arctan ( - \frac{‖ {b}^{->} ‖ {a}_{2} + ‖ {a}^{->} ‖ {b}_{2}}{‖ {a}^{->} ‖ {b}_{3} + ‖ {b}^{->} ‖ {a}_{3}} )$$

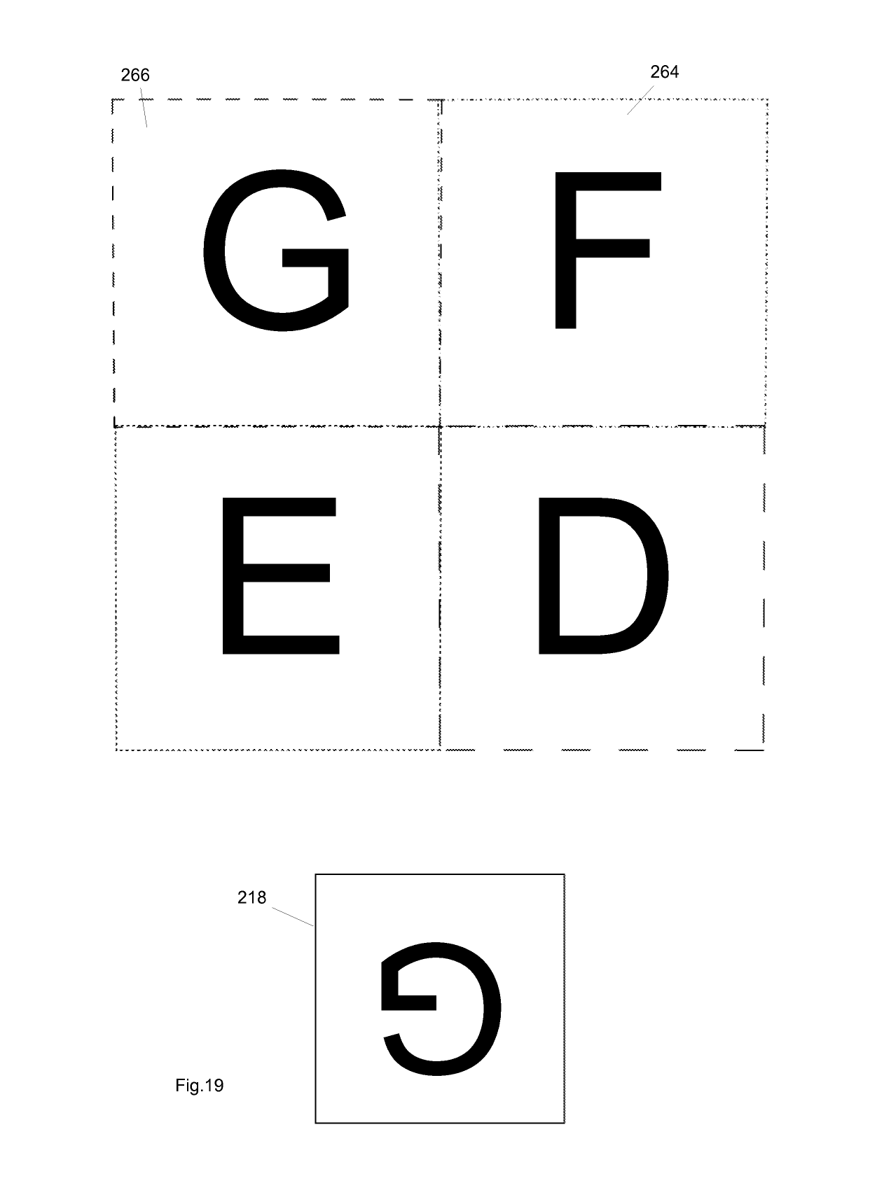

FIG. 19 shows an example viewing surface 202 divided into four areas created by a square image source 218. As can be seen by looking at the edges of area 264 and its adjacent area 266 each adjacent area slightly overlaps, this is due to the geometric distortion described above. Each area on the example viewing surface 202 receives an inverted mirror image, for example, area 266 receives the image displayed on image source 218 in the correct orientation.

The apparatus is operated by control circuitry or software means implementing the control logic as described in the flowchart of FIG. 18, the control logic responsive to the receipt of input frames appropriate to the viewing surface and its predetermined division into areas.

Frames are input in an arbitrary order and each frame carries information which identifies the area on the viewing surface 202 to receive the image, this information either contains the required angles of the scanning mirror 210 or information to otherwise allow the control logic to operate the scanning mirror 210 to direct the image to the correct area on the viewing surface 202.

On receipt of input frames (300) the control logic selects the next frame received (330) and identifies from the information associated with the frame the area on the viewing surface 202 where the image is to be displayed.

The image path is next set up (340) with the scanning mirror 210 operated such that the position of the scanning mirror required to direct the image to the specified area for the selected input frame is obtained.

The image associated with the selected input frame is generated (350) on the image source 218 and the control logic waits for the image to be completely generated (360).

The control logic returns to step 315 and if there are no more input frames the control logic stops (320) and waits for the next set of input frames, otherwise the next input frame in the set is selected (330) for display and the control logic repeats the process described above with the new frame.

An apparatus similar to the second apparatus embodying principles of the invention uses an assembly comprising an image source and focusing means. The entire assembly being rotated around the focus of the paraboloid with the focusing means configured such that the image output from the image source is focused on the focus of the paraboloid and directed onto the parabolic mirror.

Although specific embodiments of the invention have been shown and described herein, it is to be understood that these embodiments are merely illustrative of the many possible specific arrangements that can be devised in application of the principles of the invention. Numerous and varied other arrangements can be devised by those of ordinary skill in the art without departing from the scope and spirit of the invention.

Any element in a claim that does not explicitly state “means for” performing a specified function, or “step for” performing a specific function, is not to be interpreted as a “means” or “step” clause as specified in 35 U.S.C. §112, ¶6. In particular, the use of “step of” in the claims herein is not intended to invoke the provisions of 35 U.S.C. §112, ¶6.

What I claim is:

1. A method for displaying visual information on a viewing surface comprising:
(a) generating an image for each of a plurality of input frames, a plurality of the images being generated on the same display device, and;
(b) directing each image onto a different area of the viewing surface, the images being directed onto the viewing surface in such a way that:
(i) the illusion of a single image being displayed on the viewing surface is created, and;
(ii) said different areas do not occupy substantially the same area.

2. The method of claim 1 further comprising adapting the generated images for display on the viewing surface.

3. The method of claim 1 further comprising dividing the viewing surface into areas.

4. The method of claim 3 wherein directing each image onto a different area of the viewing surface further comprises directing the image to the viewing surface such that the image is received by the viewing surface substantially perpendicular to the plane of the receiving area.

5. The method of claim 1 wherein directing each image onto a different area of the viewing surface further comprises directing the image to the viewing surface such that the image is received by the viewing surface substantially perpendicular to the plane of the receiving area.

6. The method of claim 5 further comprising adapting the generated images for display on the viewing surface.

7. The method of claim 5 further comprising adapting the generated images to be suitable for direction by the directing step.

8. A display device for displaying an image on a viewing surface, the display device comprising:
(a) an image source, and;
(b) means for directing the image output from the image source to one of a plurality of areas on the viewing surface, the image output directed such that:
(i) each image in a sequence of images output from the image source is viewable via a different area of the viewing surface, and;
(ii) said different areas do not occupy substantially the same area.

9. The display device of claim 8 wherein the areas of said plurality of areas are continuous.

10. The display device of claim 8 wherein the areas receiving image output on the viewing surface are contiguous.

11. The display device of claim 8 wherein the image source generates images at a rate such that the illusion of a single image being displayed on the viewing surface is created.

12. The display device of claim 11 wherein the areas of said plurality of areas are continuous.

13. The display device of claim 11 wherein the means for directing comprises reflecting means.

14. The display device of claim 8 wherein the image source generates a two dimensional image.

15. The display device of claim 14 wherein the image source generates images at a rate such that the illusion of a single image being displayed on the viewing surface is created.

16. The display device of claim 14 wherein the means for directing comprises reflecting means.

17. The display device of claim 16 further comprising an optical reducer adapted to reduce the image output from the image source.

18. The display device of claim 16 further comprising means for focusing the image output from the image source upon the viewing surface.

19. The display device of claim 8 further comprising a viewing surface.

20. The display device of claim 19 wherein the image source generates images at a rate such that the illusion of a single image being displayed on the viewing surface is created.

21. The display device of claim 20 wherein the means for directing comprises reflecting means.

22. The display device of claim 19 wherein the viewing surface comprises a plurality of lenses.

23. A display apparatus comprising:
(a) a viewing surface;
(b) a first display device, and;
(c) one or more mirrors configured such that the image generated by the first display device is directable to one of a plurality of areas on the viewing surface by actuating at least one of the mirrors.

24. The display apparatus of claim 23 wherein the one or more mirrors comprises a MEMS mirror array.

25. The display apparatus of claim 23, wherein the first display device generates a two dimensional image.

26. The display apparatus of claim 25 wherein the one or more mirrors comprises a MEMS mirror array.

27. The display apparatus of claim 23 wherein the viewing surface comprises an array of lenses.

28. The display apparatus of claim 27, wherein the mirrors and the first display device are configured such that the image generated by the first display device is received substantially perpendicular to the plane of the receiving area on the viewing surface when the at least one of the mirrors is actuated.

29. The display apparatus of claim 27 wherein the one or more mirrors comprises a MEMS mirror array.

30. The display apparatus of claim 27 operating as an auto-stereoscopic display device.

31. The display apparatus of claim 27, wherein the first display device generates a two dimensional image.

32. The display apparatus of claim 31 wherein the one or more mirrors comprises a MEMS mirror array.

33. The display apparatus of claim 32, wherein the mirrors and the first display device are configured such that the image generated by the first display device is received substantially perpendicular to the plane of the receiving area on the viewing surface when the at least one of the mirrors is actuated.

34. The display apparatus of claim 32 wherein the mirrors of the MEMS mirror array can be actuated to be inclined to 45 degrees from the plane of the MEMS mirror array.

35. The display apparatus of claim 32, further comprising an optical reducer optically positioned to reduce the image being generated by the first display device.

36. The display apparatus of claim 31 wherein the one or more mirrors comprises a movable scanning mirror.

37. The display apparatus of claim 31 wherein the one or more mirrors comprises:
(a) a mirrored parabola, and;
(b) a movable scanning mirror.

38. The display apparatus of claim 36 further comprising a lens adapted to focus the output of the first display device.
